(19) United States
(12) Patent Application Publication
(10) Pub. No.: US 2017/0073621 A1
(43) Pub. Date: Mar. 16, 2017

(54) SOAP COMPRISING BIOSURFACTANTS

(71) Applicant: Henkel AG & Co. KGaA, Duesseldorf (DE)

(72) Inventor: Heike Schelges, Willich (DE)

(73) Assignee: Henkel AG & Co. KGaA, Duesseldorf (DE)

(21) Appl. No.: 15/254,635

(22) Filed: Sep. 1, 2016

(30) Foreign Application Priority Data
Sep. 14, 2015 (DE) 10 2015 217 506.5

(51) Int. Cl. C11D 10/04; C11D 17/00

(52) U.S. Cl. CPC C11D 10/045; C11D 17/0047

(57) ABSTRACT

A soap, in particular a bar of soap, includes fatty acid soaps and biosurfactants as main components. A soap can thus be provided that has excellent foaming performance, good dermatological compatibility and a good feeling on the skin, the ingredients of which can be largely or exclusively based on renewable raw materials and which are easily biodegradable.

### FIELD OF THE INVENTION

The present invention generally relates to soap, and more particularly relates to a bar of soap, which includes fatty acid soaps as main components.

### BACKGROUND OF THE INVENTION

Bars of soap, in particular toilet soaps or fine soaps, are often based on mixtures of beef tallow and coconut oil. This fat blend is hydrolyzed by adding sodium hydroxide to form the base soap, to which additional additives such as humectants, fillers and binders, superfatting agents, dyes and perfume substances etc. are added. Conventional fine soaps include fatty acid salts, 10% water and up to 100% auxiliary substances and additives. Soaps per se are thus already very natural and sustainable cleaning agents, since they are derived from fats and oils which occur in nature. In practice, however, synthetic surfactants, i.e. those anionic, cationic, non-ionic, amphoteric and/or zwitterionic surfactants which are generally not obtained from natural raw materials, are often added to soaps to improve the foaming performance and dermatological compatibility. Soaps of this kind are referred to as combibars. Soaps without fatty acid salts, which exclusively include synthetic surfactants, are known under the name Syndet.

The mentioned soaps (combibars) which, in addition to the fatty acid salts, include anionic, amphoteric, non-ionic and cationic, have a good cleaning power and a good foaming behavior. However, most of these surfactants are obtained completely or in part from petrochemicals. It is, however, becoming ever more important for cosmetic ingredients to be sustainable and this is increasingly demanded by consumers and manufacturers of cosmetic cleaning agents.

Biosurfactants are surface-active substances of microbial origin that can be produced using a substrate of plant oils or sugar. Some of these substrates can consist of agricultural waste such as rice husks or wastewater from the sugar industry, and so in this case no basic materials for food production are wasted. Biosurfactants thus satisfy the requirements of sustainability since they are produced from renewable raw materials. They are used in domestic cleaning agents, washing detergents and dishwasher detergents (e.g. U.S. Pat. No. 5,520,839, DE 19600743 A1), as well as in various cosmetic cleaning agents (e.g. WO 2014/095367 A1, WO 2013/098066 A2).

However, biosurfactants alone generally have a limited foaming performance.

It is therefore desirable to provide soaps, in particular bars of soap, which largely or exclusively include natural ingredients and, despite complete or substantial absence of synthetic surfactants, have excellent foaming behavior and a good feeling on the skin.

Furthermore, other desirable features and characteristics of the present invention will become apparent from the subsequent detailed description of the invention and the appended claims, taken in conjunction with this background of the invention.

### BRIEF SUMMARY OF THE INVENTION

A soap which includes the following components, each in wt. % based on the total weight of the soap: 0.5 to 90 wt. % sodium, potassium and/or ammonium salts of fatty acids having 6 to 30 carbon atoms; and 1 to 50 wt. % of one or more biosurfactants.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It was surprisingly found that the above-described objectives be achieved by soaps which include biosurfactants in addition to the usual fatty acid salts. The properties with regard to washing behavior, feeling on the skin and foaming performance were in this case comparable with those of combibars.

The present invention relates to:
1. A soap which includes the following components, each in wt. % based on the total weight of the soap:
a) 0.5 to 90 wt. % sodium, potassium and/or ammonium salts of fatty acids having 6 to 30 carbon atoms, and
b) 1 to 50 wt. % of one or more biosurfactants.
2. The soap according to point 1, which includes
a) 20 to 85 wt. % sodium, potassium and/or ammonium salts of fatty acids having 6 to 30 carbon atoms, and
b) 1 to 20 wt. % of one or more biosurfactants, each based on the total weight of the soap.
3. The soap according to point 1 or 2, wherein sodium, potassium and/or ammonium salts, preferably sodium salts, of tallow fatty acids, coconut fatty acids, olive oil fatty acids, palm oil fatty acids, lard fatty acids, palm kernel oil fatty acids or a combination thereof, are included as component (a).
4. The soap according to one of the preceding points, which includes a glycolipid, a lipopeptide or a combination thereof as the biosurfactant.
5. The soap according to one of the preceding points, which includes a rhamnolipid, a sophorolipid, a mannosylerythritol, a surfactin, a fatty acyl glutamate, a fatty acyl glycinate or a combination thereof as the biosurfactant.
6. The soap according to point 5, which includes a sophorolipid as the biosurfactant, preferably a mixture of the acidic form and lactone form, wherein 20 to 60 wt. % is in the acidic form.
7. The soap according to point 6, which includes a rhamnolipid as the biosurfactant, preferably a mixture of mono- and dirhamnolipid, which are each derived from 3-hydroxydodecanoic acid and 3-hydroxyundecanoic acid.
8. The soap according to one of the preceding points, which also includes 0.1 to 10 wt. % of a non-ionic surfactant, in particular alkyl polyglycoside(s), fatty acyl glucamide(s) or a combination thereof.
9. The soap according to one of the preceding points, which includes 0.5 wt. % or less, preferably no, anionic, cationic, amphoteric and/or zwitterionic surfactants.
10. The soap according to one of the preceding points, which also includes one or more components selected from fillers, free fatty acids, fragrances or perfumes, antioxidants, complexing agents, caring substances and humectants.
11. The soap according to point 10, wherein the filler is selected from talc, starch such as maize or wheat starch, calcium carbonate, cellulose and combinations thereof.

The soap according to the invention includes one or more biosurfactants as an essential component.

Biosurfactants are understood to be substances that are formed by microorganisms and are often expelled from the cell. Like classic surfactants, biosurfactants are surface-active substances that reduce the surface tension of liquids and thereby promote the mixing of aqueous (hydrophilic) and water-repellent (hydrophobic) phases. Biosurfactants can be produced under gentle production conditions that require little energy. They are generally easily biodegradable and are very environmentally friendly. Moreover, they are not toxic, nor are any toxic byproducts produced during the production thereof. Carbohydrates, in particular sugar, e.g. glucose, and/or lipophilic carbon sources such as fats, oils, partial glycerides, fatty acids, fatty alcohols, long-chain saturated or unsaturated hydrocarbons, are used as raw materials for the microbial production of said biosurfactants. According to the invention, the biosurfactants are preferably biosurfactants produced by fermentation.

Biosurfactants include glycolipids, lipopeptides, lipoproteins, fatty acids, phospholipids, neutral lipids and polymeric surfactants (e.g. emulsan), which can all also be used in the present invention.

Glycolipids that can be used in the present invention are compounds in which one or more monosaccharide units are glycosidically bonded to a lipid moiety. Examples of glycolipids as biosurfactants that can be used according to the invention are rhamnolipids, sophorolipids, mannosylerythritol lipids and trehalose lipids. Of these, rhamnolipids, sophorolipids, mannosylerythritol lipids and combinations thereof are preferred.

Rhamnolipids are obtained from bacteria of the genus Pseudomonas, in particular from Pseudomonas aeruginosa, preferably when grown on hydrophobic substrates such as n-alkanes or plant oils. Other glycolipids, for example glucose lipids, cellobiose lipids or trehalose lipids, are in turn produced by other microorganisms on different substrates. According to the invention, mannosylerythritol lipids are also preferred glycolipid biosurfactants; they are produced by Pseudozyma sp., Candida antarctica and Ustilago sp. bacteria.

According to the invention, rhamnolipids have the following general formula:

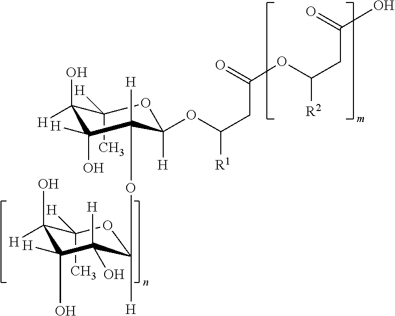

where m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated, and where the alkyl functional group is preferably a linear saturated alkyl functional group having 8 to 12 carbon atoms, more preferably is a nonyl or a decyl functional group or a mixture thereof.

Salts of these compounds are also included according to the invention.

In the present invention, the term “dirhamnolipid” is understood to mean compounds of the above formula or the salts thereof in which n is 1.

Accordingly, “monorhamnolipid” is understood in the present invention to mean compounds of the general formula or the salts thereof in which n is 0.

Mixtures of mono- and dirhamnolipids can preferably be used according to the invention. In this case, the ratio of monorhamnolipid to dirhamnolipid is preferably approximately 2:1 to 4:1, more preferably 2.5:1 to 3:1. Particularly preferred are those mixtures of mono- and dirhamnolipid in which, in the above formula, R¹ and R² independently represent a linear nonyl or decyl functional group. In the latter case, these are therefore rhamnolipids that are each derived from 3-hydroxydodecanoic acid and/or 3-hydroxyundecanoic acid. Mixtures of this type can be obtained commercially for example under the name Rhamnolipid R90, R95 or R98 from Agae Technologies, USA, the number indicating the purity in each case. Rhamnolipid R90 can be used particularly preferably according to the invention.

Sophorolipids are produced by fermentation using yeasts such as Candida bombicola (also known as Torulopsis bombicola), Yarrowia lipolytica, Candida apicola (Torulopsis apicola) and Candida bogoriensis, by growing said yeasts on sugars, hydrocarbons, plant oils or mixtures thereof.

Sophorolipids have the following formulae (1) (lactone form) and (2) (free acid), the two forms typically being provided in a mixture,

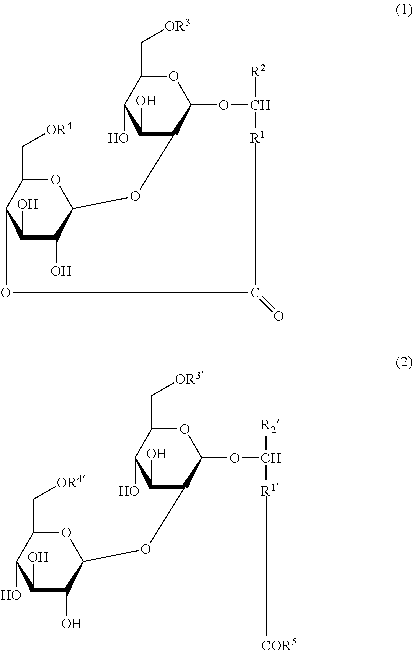

where R¹ and R^{1′} independently represent saturated hydrocarbon chains or single or multiple, in particular single, unsaturated hydrocarbon chains having 8 to 20, in particular 12 to 18, carbon atoms, more preferably 14 to 18 carbon atoms, which can be linear or branched and can include one or more hydroxy groups,
R2 and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can include one or more hydroxy groups, and
R³, R^{3′}, R⁴ and R^{4′} independently represent a hydrogen atom or an acetyl group.

Sophorolipids in which R¹ and R^{1′} are single, unsaturated, linear hydrocarbon chains having 15 carbon atoms are preferred. It is also preferred for R² and R²′ to represent a methyl group or a hydrogen atom, even more preferably for each to represent a methyl group.

According to the invention, sophorolipids in which the acidic form and the lactone form are in a mixture are preferred, preferably approximately 20 to approximately 60 wt. % of the sophorolipid being in the acidic form and the remainder of the sophorolipid being in the lactone form.

In particular, sophorolipids are preferred in which compounds of the above formulae (1) and (2) are present in a mixture, where R¹ and R^{1′} represent a single, unsaturated, linear hydrocarbon chain having 14 to 18 carbon atoms, even more preferably 15 carbon atoms, R³ and R⁴ represent an acetyl group, R^{3′} and R^{4′} represent a hydrogen atom and R² and R^{2′} represent a methyl group, and approximately 20 to 60 wt. % of the sophorolipids are in the acidic form.

Sophorolipids of this type can be obtained commercially, for example under the name Sopholiance S from Soliance. More precisely, the sophorolipid that can be obtained under the trade name Sopholiance S from Soliance is an approximately 60 wt. % sophorolipid solution and is, for example, obtained by fermenting Candida bombicola on rapeseed oil methyl ester and glucose (INCI: Candida bombicola/glucose/methyl rapeseed ferment (and) water). Sopholiance S is a preferred sophorolipid according to the invention.

In Soliance S, approximately 20 wt. % is present in the free acid form, in a mixture with the lactone form.

Mannosylerythritol lipids are glycolipids of the following general formula:

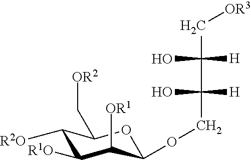

where R¹ independently represents fatty acid acyl groups having 4 to 24 carbon atoms, preferably 8 to 12 carbon atoms, R² independently represents a hydrogen atom or an acetyl group, and R³ represents a hydrogen atom or a fatty acid acyl group having 2 to 24 carbon atoms. A mannosylerythritol lipid that is suitable according to the invention can be obtained commercially under the name Ceramela-B (Toyobo) (INCI: Pseudozyma tsukubaensis/

olive oil/glycerin/soy protein ferment).

The lipids and lipid derivatives substance group, to which in particular lipopeptides belong, is also included in the biosurfactants. In general, lipopeptides are synthesized non-ribosomally by the respective microorganisms, for example by Gram-positive bacteria, in particular of the genera Bacillus and Streptomyces, by Gram-negative bacteria, in particular of the genus Pseudomonas, by Myxobacteria, and by filamentous fungi. Normally, the peptide chains consist of two to forty amino acids, and can be linear, cyclic or branched. Unlike ribosomally synthesized peptide chains, lipopeptides often include not only proteinogenic L-amino acids as the monomer structural elements, but also D-amino acids and carboxylic acids and/or all types of alpha-hydroxy carboxylic acids. The amino acids are mostly L-α- or D-α-amino acids, although β-, γ- or δ-amino acids can also be present, which can likewise also be in a D- or L-configuration. The peptide chains can also include other chemical modifications; in particular they can be glycolyzed, hydrolyzed, N-methylated or N-formylated. Common structural elements are also thiazoline rings and/or oxazoline rings in various oxidation stages. A known lipopeptide biosurfactant is surfactin, which has the following structure and is generally used as an alkali salt or ammonium salt:

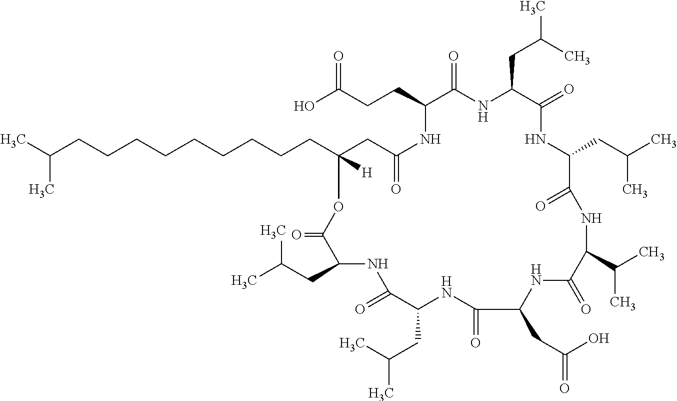 [SMILES: CC(C)CCCCCCCCC[C@@H]1CC(=O)N[C@@H](CCC(=O)O)C(=O)N[C@@H](CC(C)C)C(=O)N[C@H](CC(C)C)C(=O)N[C@@H](C(C)C)C(=O)N[C@@H](CC(=O)O)C(=O)N[C@H](CC(C)C)C(=O)N[C@@H](CC(C)C)C(=O)O1]

A surfactin that is suitable according to the invention can be obtained commercially from Kaneka.

The lipopeptides that can preferably be used according to the invention as biosurfactants also include fatty acyl glutamates. These have the following general formula:

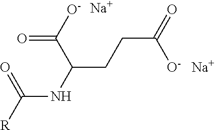

where R is a straight or branched alkyl chain having 5 to 21 carbon atoms, preferably 7 to 17 carbon atoms, more preferably 12 to 16 or 13 to 15 carbon atoms. Fatty acyl glutamates in the form of biosurfactants are generally provided in a mixture in which R has different chain lengths. The functional group R can also be hydroxylated, preferably by a single hydroxylation, in which case hydroxylation at β-position is preferred. Fatty acyl glutamates in the form of biosurfactants can, for example, be obtained from Modular Genetics, Inc., USA.

The lipopeptides that can preferably be used according to the invention as biosurfactants also include fatty acyl glycinates. These have the following general formula:

RC(O)NHCH₂CO₂X,

where
R is a straight or branched alkyl chain having 5 to 21 carbon atoms, preferably 7 to 17 carbon atoms, more preferably 12 to 16 or 13 to 15 carbon atoms, and
X is a cation, preferably an alkali metal cation or an ammonium cation, more preferably a sodium or ammonium cation, or —H.

Fatty acyl glycinates in the form of biosurfactants can also be present in a mixture in which R can include different chain lengths.

Fatty acyl glycinates in the form of biosurfactants can be obtained, for example, from Modular Genetics, Inc., USA.

According to the invention, soaps are preferred that include the following biosurfactants or biosurfactant combinations: Rhamnolipid(s), sophorolipid(s), fatty acyl glutamate, fatty acyl glycinate, surfactin, mannosylerythritol lipid, rhamnolipid(s)+fatty acyl glutamate, rhamnolipid(s)+sophorolipid(s), fatty acyl glutamate+mannosylerythritol lipid(s).

The soap according to the invention includes the biosurfactants in a quantity of approximately 1 to 50 wt. %, preferably approximately 1 to 20 wt. %, more preferably approximately 1 to 15 wt. %, more preferably 1.5 to 10 wt. %, also preferably 1.5 to 7.5 wt. % based on the total weight of the soap. If biosurfactant mixtures are used, the percentages relate to the total amount of biosurfactants included.

The soap of the present invention includes fatty acid salts or “fatty acid soaps” as another essential component, referred to as sodium, potassium or ammonium salts of fatty acids. According to the invention, “fatty acids” are understood as linear and/or branched saturated and/or unsaturated carboxylic acids having 6 to 30 C atoms, e.g. caproic acid, caprylic acid, 2-ethylhexanoic acid, capric acid, lauric acid, myristic acid, palmitic acid, stearic acid, arachidic acid and behenic acid, erucic acid, isostearic acid, isotridecanoic acid, but also elaidic acid, petroselinic acid, eleostearic acid, arachidic acid, gadoleic acid, palmitoleic acid, oleic acid, linoleic acid, linolenic acid and arachidonic acid. Preferred in this case are linear and/or branched, saturated and/or unsaturated carboxylic acids having 10 to 22 C atoms, also preferably 12 to 18 carbon atoms.

Technical mixtures are preferably used such as those obtainable from plant and animal fats and oils, e.g. from tallow fatty acids, coconut fatty acids, olive oil fatty acids, palm oil fatty acids, lard fatty acids and/or palm kernel oil fatty acids.

Particularly preferable for the use according to the invention are the sodium salts of the following fatty acids: tallow fatty acid (INCI name: sodium tallowate), coconut fatty acid (INCI name: sodium cocate), olive oil fatty acids (INCI name: sodium olivate), palm oil fatty acids (INCI name: sodium palmate), lard fatty acids (INCI name: sodium lardate) and/or palm kernel oil fatty acids (INCI name: sodium palm kernelate).”

If a softer consistency of the soap is desired, for example liquid-pasty, some of the sodium salts can be replaced by potassium salts.

The soap according to the invention includes the fatty acid salts in a quantity of approximately 0.5 to 90 wt. %, preferably approximately 10 to 85 wt. %, more preferably approximately 20 to 85 wt. %, more preferably 40 to 80 wt. %, also preferably 50 to 80 wt. % based on the total weight of the soap. If fatty acid salt mixtures are used, the percentages relate to the total amount of fatty acid salts included.

The soap according to the invention is preferably a bar of soap, i.e. a soap having a solid consistency. The soap according to the invention can, however, if desired, be in a pasty-liquid form or in a liquid form.

In preferred embodiments, the soap according to the invention includes, apart from the biosurfactants and fatty acid salts, 0.5 wt. % or less, even more preferably no, other surfactants, i.e. no other non-ionic, anionic, cationic, amphoteric and/or zwitterionic surfactants.

In other preferred embodiments, the soap according to the invention includes 0.5 wt. % or less, preferably no, anionic, cationic, amphoteric and/or zwitterionic surfactants. In these cases, non-ionic surfactants can be included in amounts of 0.1 to 10 wt. %. In these cases, the non-ionic surfactants are also preferably sugar-based non-ionic surfactants such as alkyl polyglycosides and/or fatty acid N-alkyl glucamides, which are also referred to as fatty alkyl glucamides.

The soap according to the invention preferably also includes one or more components as additives, which are selected from fillers, free fatty acids, fragrances or perfumes, antioxidants, complexing agents, caring substances and humectants. However, other additives can also be included according to the invention.

The fatty acid salts, biosurfactants and additives preferably add up to approximately 85 to 98 wt. %, more preferably approximately 88 to 95 wt. % and up to 100% water.

Fillers include in particular natural, optionally water-soluble, fillers, such as talc, starch such as maize starch or wheat starch, calcium carbonate, cellulose and combinations thereof.

Fatty acids having an aliphatic, linear or branched acyl residue having 6 to 30, preferably 10 to 22, more preferably 12 to 18 carbon atoms and 0 and/or 1, 2 or 3 double bonds can be included as free fatty acids which can be used to replenish lipids in the skin. Typical examples are caproic acid, caprylic acid, 2-ethylhexanoic acid, capric acid, lauric acid, myristic acid, palmitic acid, stearic acid, arachidic acid and behenic acid, erucic acid, isostearic acid, isotridecanoic acid, but also elaidic acid, petroselinic acid, eleostearic acid, arachidic acid, gadoleic acid, palmitoleic acid, oleic acid, linoleic acid, linolenic acid and arachidonic acid. Technical fatty acids having 12 to 18 carbon atoms such as coconut oil, palm oil, palm kernel oil or tallow fatty acids are preferred, which correspond to the relevant salts of component (a).

The free fatty acids can be included in the soap for example in amounts of 0.1 to 10 wt. %, preferably 1 to 7 wt. %, this being the total amount of free fatty acids in the soap.

According to the invention, in particular natural fragrances are preferred as fragrances or perfumes which can be included in the soap. If a fragrance is included, it is preferably included in an amount of 0.05 to 3 wt. %, preferably 0.1 to 2 wt. %, more preferably 0.2 to 1 wt. %, and also preferably 0.5 to 1 wt. %, in each case based on the total weight of the cleaning agent. If a plurality of fragrances are included, the percentages relate to the total amount of fragrances or perfumes.

Typical antioxidants which can be used according to the invention are t-butylhydroxytoluene or vitamin (tocopheryl acetate). Typical complexing agents which can be used according to the invention are salts of the 1-hydroxyethane-1,1-diphosphonic acids (INCI: tetrasodium etidronate) or of the ethylenediaminetetraacetic acid (INCI: tetrasodium EDTA).

As a caring substance, the soap can, for example, include oil components, preferably natural oil components such as plant oils and fats and plant extracts, but also monosaccharides or oligosaccharides and/or lipids. Aloe vera extracts (INCI: aloe barbadensis leaf juice), lanolin, niacinamide, avocado oil or olive oil are mentioned as examples.

The soap can include for example glycerine and/or lactate as humectants.

Bars of soap according to the invention can be produced in the usual way for products of this kind. Conventional methods for mixing, homogenizing, kneading, optionally refining, extruding, optionally pelletizing, extrusion molding, cutting and pressing into bars are routine for a person skilled in the art and can be used for producing the bars of soap according to the invention. The production is preferably carried out in a temperature range of between 40 and 90° C., meltable starting materials being provided in a heatable kneader or mixer and the non-meltable components being stirred in. For homogenization, the mixture can subsequently be sieved, before the shaping process follows.

Overview in tables:

Preferred cosmetic cleaning agents for the cleaning agent system according to the invention are set out below. All the information is given in wt. % and relates to the active ingredient concentration. Particularly preferred are the soaps having compositions according to the formulae 9, 10, 14, 15, 19, 20, 24, 25, 29, 30, 34, 35, 39, 40, 44, 45, 49 and 50.

| | Formula 1 | Formula 2 | Formula 3 | Formula 4 | Formula 5 |
|---|---|---|---|---|---|
| Sodium, potassium | 0.5 to 90 | 10 to 85 | 20 to 85 | 40 to 80 | 50 to 80 |
| and/or ammonium salts | | | | | |
| of fatty acids having | | | | | |
| 6 to 30 carbon atoms | | | | | |
| Biosurfactant | 1 to 50 | 1 to 25 | 1 to 20 | 1.5 to 10 | 1.5 to 7.5 |
| Misc. | Total to 100 | Total to 100 | Total to 100 | Total to 100 | Total to 100 |
| | Formula 6 | Formula 7 | Formula 8 | Formula 9 | Formula 10 |
| Sodium, potassium | 0.5 to 90 | 10 to 85 | 20 to 85 | 40 to 80 | 50 to 80 |
| and/or ammonium salts | | | | | |
| of tallow fatty acids, | | | | | |
| coconut fatty acids, | | | | | |
| olive oil fatty acids, | | | | | |
| palm oil fatty acids, lard | | | | | |
| fatty acids and/or palm | | | | | |
| kernel oil fatty acids | | | | | |
| Rhamnolipid, | 1 to 50 | 1 to 25 | 1 to 20 | 1.5 to 10 | 1.5 to 7.5 |
| sophorolipid, | | | | | |
| mannosylerythritol, | | | | | |
| surfactin, fatty acyl | | | | | |
| glutamate and/or fatty | | | | | |
| acyl glycinate | | | | | |
| Misc. | Total to 100 | Total to 100 | Total to 100 | Total to 100 | Total to 100 |
| | Formula 11 | Formula 12 | Formula 13 | Formula 14 | Formula 15 |
| Sodium salts of tallow | 0.5 to 90 | 10 to 85 | 20 to 85 | 40 to 80 | 50 to 80 |
| fatty acids, coconut | | | | | |
| fatty acids, olive oil | | | | | |
| fatty acids, palm oil | | | | | |
| fatty acids, lard fatty | | | | | |
| acids and/or palm kernel | | | | | |
| oil fatty acids | | | | | |
| Rhamnolipid | 1 to 50 | 1 to 25 | 1 to 20 | 1.5 to 10 | 1.5 to 7.5 |
| Misc. | Total to 100 | Total to 100 | Total to 100 | Total to 100 | Total to 100 |
| | Formula 16 | Formula 17 | Formula 18 | Formula 19 | Formula 20 |
| Sodium salts of | 0.5 to 90 | 10 to 85 | 20 to 85 | 40 to 80 | 50 to 80 |
| tallow fatty acids, | | | | | |
| coconut fatty acids, | | | | | |
| olive oil fatty acids, | | | | | |
| palm oil fatty acids, lard | | | | | |
| fatty acids and/or palm | | | | | |
| kernel oil fatty acids | | | | | |
| Sophorolipid | 1 to 50 | 1 to 25 | 1 to 20 | 1.5 to 10 | 1.5 to 7.5 |
| Misc. | Total to 100 | Total to 100 | Total to 100 | Total to 100 | Total to 100 |
| | Formula 21 | Formula 22 | Formula 23 | Formula 24 | Formula 25 |
| Sodium salts of | 0.5 to 90 | 10 to 85 | 20 to 85 | 40 to 80 | 50 to 80 |
| tallow fatty acids, | | | | | |
| coconut fatty acids, | | | | | |
| olive oil fatty acids, | | | | | |
| palm oil fatty acids, lard | | | | | |
| fatty acids and/or palm | | | | | |
| kernel oil fatty acids | | | | | |
| Fatty acyl glutamate | 1 to 50 | 1 to 25 | 1 to 20 | 1.5 to 10 | 1.5 to 7.5 |
| Misc. | Total to 100 | Total to 100 | Total to 100 | Total to 100 | Total to 100 |
| | Formula 26 | Formula 27 | Formula 28 | Formula 29 | Formula 30 |
| Sodium salts of | 0.5 to 90 | 10 to 85 | 20 to 85 | 40 to 80 | 50 to 80 |
| tallow fatty acids, | | | | | |
| coconut fatty acids, | | | | | |
| olive oil fatty acids, | | | | | |
| palm oil fatty acids, lard | | | | | |
| fatty acids and/or palm | | | | | |
| kernel oil fatty acids | | | | | |
| Surfactin | 1 to 50 | 1 to 25 | 1 to 20 | 1.5 to 10 | 1.5 to 7.5 |
| Misc. | Total to 100 | Total to 100 | Total to 100 | Total to 100 | Total to 100 |
| | Formula 31 | Formula 32 | Formula 33 | Formula 34 | Formula 35 |
| Sodium salts of tallow | 0.5 to 90 | 10 to 85 | 20 to 85 | 40 to 80 | 50 to 80 |
| fatty acids, coconut | | | | | |
| fatty acids, olive oil | | | | | |
| fatty acids, palm oil | | | | | |
| fatty acids, lard fatty | | | | | |
| acids and/or palm kernel | | | | | |
| oil fatty acids | | | | | |
| Mannosylerythritol lipid | 1 to 50 | 1 to 25 | 1 to 20 | 1.5 to 10 | 1.5 to 7.5 |
| Misc. | Total to 100 | Total to 100 | Total to 100 | Total to 100 | Total to 100 |
| | Formula 32 | Formula 33 | Formula 34 | Formula 35 | Formula 36 |
| Sodium salts of tallow | 0.5 to 90 | 10 to 85 | 20 to 85 | 40 to 80 | 50 to 80 |
| fatty acids, coconut | | | | | |
| fatty acids, olive oil | | | | | |
| fatty acids, palm oil | | | | | |
| fatty acids, lard fatty | | | | | |
| acids and/or palm kernel | | | | | |
| oil fatty acids | | | | | |
| Fatty acyl glycinate | 1 to 50 | 1 to 25 | 1 to 20 | 1.5 to 10 | 1.5 to 7.5 |
| Misc. | Total to 100 | Total to 100 | Total to 100 | Total to 100 | Total to 100 |
| | Formula 36 | Formula 37 | Formula 38 | Formula 39 | Formula 40 |
| Sodium salts of tallow | 0.5 to 90 | 10 to 85 | 20 to 85 | 40 to 80 | 50 to 80 |
| fatty acids, coconut | | | | | |
| fatty acids, olive oil | | | | | |
| fatty acids, palm oil | | | | | |
| fatty acids, lard fatty | | | | | |
| acids and/or palm kernel | | | | | |
| oil fatty acids | | | | | |
| Rhamnolipid and fatty | 1 to 50 | 1 to 25 | 1 to 20 | 1.5 to 10 | 1.5 to 7.5 |
| acyl glutamate | | | | | |
| Misc. | Total to 100 | Total to 100 | Total to 100 | Total to 100 | Total to 100 |
| | Formula 41 | Formula 42 | Formula 43 | Formula 44 | Formula 45 |
| Sodium salts of tallow | 0.5 to 90 | 10 to 85 | 20 to 85 | 40 to 80 | 50 to 80 |
| fatty acids, coconut fatty | | | | | |
| acids, olive oil fatty | | | | | |
| acids, palm oil fatty | | | | | |
| acids, lard fatty acids | | | | | |
| and/or palm kernel oil | | | | | |
| fatty acids | | | | | |
| Rhamnolipid and | 1 to 50 | 1 to 25 | 1 to 20 | 1.5 to 10 | 1.5 to 7.5 |
| sophorolipid | | | | | |
| Misc. | Total to 100 | Total to 100 | Total to 100 | Total to 100 | Total to 100 |
| | Formula 46 | Formula 47 | Formula 48 | Formula 49 | Formula 50 |
| Sodium salts of tallow | 0.5 to 90 | 10 to 85 | 20 to 85 | 40 to 80 | 50 to 80 |
| fatty acids, coconut | | | | | |
| fatty acids, olive oil | | | | | |
| fatty acids, palm oil | | | | | |
| fatty acids, lard fatty | | | | | |
| acids and/or palm kernel | | | | | |
| oil fatty acids | | | | | |
| Mannosylerythritol lipid | 1 to 50 | 1 to 25 | 1 to 20 | 1.5 to 10 | 1.5 to 7.5 |
| and fatty acyl glutamate | | | | | |
| Misc. | Total to 100 | Total to 100 | Total to 100 | Total to 100 | Total to 100 |

According to the invention, “Misc.” is understood to be water and conventional ingredients of soaps such as fillers, free fatty acids, fragrances or perfumes, antioxidants, complexing agents, caring substances and humectants.

The biosurfactants and fatty acid salts preferably add up, in this case, to approximately 85 to 98 wt. %, more preferably approximately 88 to 95 wt. %, and the remainder up to 100% is preferably water

### EXAMPLES

The following bars of soap set out in the tables were produced. The percentages are to be understood as percent by weight, based in each case on the total weight of the cleaning agent.

TABLE 1

| | Exam- | Exam- | Exam- | Exam- | Exam- | Exam- |
|---|---|---|---|---|---|---|
| INCI | ple 1 | ple 2 | ple 3 | ple 4 | ple 5 | ple 6 |
| Sodium | 47.60 | — | — | 25 | 50 | 50 |
| tallowate | | | | | | |
| Sodium olivate | — | — | 75 | — | — | — |
| Sodium | — | 47.60 | — | — | — | — |
| palmate | | | | | | |
| Sodium lardate | — | — | — | 25 | — | — |
| Sodium sulfate | — | — | — | — | 4.00 | — |
| Rhamnolipid | — | — | — | — | — | — |
| Talc | 20.00 | 20.00 | 5.00 | 15.00 | 10.00 | 10.00 |
| Surfactin | — | — | 5.00 | — | — | — |
| Mannosyl- | — | — | — | — | — | 2.00 |
| erythritol- | | | | | | |
| lipid | | | | | | |
| Rhamnolipid | — | — | — | 5.00 | 3.00 | — |
| Sophorolipid | 5.00 | — | — | — | 2.00 | — |
| Fatty acyl | — | 5.00 | — | 3.00 | — | 2.00 |
| glutamate | | | | | | |
| Fatty acyl | 5.00 | — | 5.00 | — | — | — |
| glycinate | | | | | | |
| Corn starch | — | — | — | — | — | — |
| Sodium | 10.00 | — | — | 20.00 | 10.00 | 20.00 |
| cocoate | | | | | | |
| Sodium palm | — | 10.00 | — | — | — | — |
| kernelate | | | | | | |
| Glycerol | 3.00 | 2.00 | 3.00 | — | 4.00 | — |
| Sorbitol | — | — | — | — | — | — |
| Perfume | 0.80 | 1.00 | 2.00 | 2.00 | 1.00 | 1.50 |
| CI 77891 | 0.50 | 0.20 | — | 0.20 | 2.50 | — |
| Coconut acid | 0.50 | — | — | — | — | 3.00 |
| Palm kernel | — | 0.50 | — | — | — | — |
| acid | | | | | | |
| Tallow acid | 0.50 | — | — | — | 2.50 | 3.00 |
| Palm acid | — | 0.50 | — | — | — | — |
| Sodium | 0.20 | 0.30 | 0.5 | 0.30 | 0.30 | 0.30 |
| chloride | | | | | | |
| Sodium lactate | 0.20 | — | — | — | 0.50 | — |
| BHT | 0.073 | 0.73 | 0.1 | — | — | 0.10 |
| Tetrasodium | 0.02 | 0.20 | — | 0.02 | 0.30 | 0.10 |
| etidronate | | | | | | |
| Tetrasodium | 0.018 | 0.18 | — | 0.02 | 0.30 | 0.10 |
| EDTA | | | | | | |
| Niacinamide | 0.01 | 0.10 | — | — | — | — |
| Aloe | 0.01 | 0.10- | 0.15 | 0.05 | — | — |
| barbedensis | | | | | | |
| leaf juice | | | | | | |
| Lanolin | — | — | — | — | — | — |
| CI 47005 | 0.006 | — | — | — | — | — |
| CI 74160 | 0.001 | — | — | 0.2-3 | — | — |
| CI 77007 | — | — | — | 0.05 | — | 0.06 |
| Aqua | Total to | Total to | Total to | Total to | Total to | Total to |
| | 100 | 100 | 100 | 100 | 100 | 100 |

TABLE 2

| | Exam- | Exam- | Exam- | Exam- | Exam- | Exam- |
|---|---|---|---|---|---|---|
| INCI | ple 7 | ple 8 | ple 9 | ple 10 | ple 11 | ple 12 |
| Sodium | — | 45 | 45 | — | — | — |
| tallowate | | | | | | |
| Sodium olivate | — | — | — | — | — | 50 |
| Sodium | 50 | — | — | 45 | 50 | — |
| palmate | | | | | | |
| Sodium lardate | — | — | — | — | — | — |
| Sodium sulfate | — | — | — | — | — | — |
| Rhamnolipid | 3.00 | — | — | — | — | — |
| Talc | 5.00 | 10.00 | 10.00 | 20.00 | — | — |
| Surfactin | — | — | — | — | — | — |
| Mannosyl- | — | — | 2.00 | — | — | — |
| erythritol- | | | | | | |
| lipid | | | | | | |
| Rhamnolipid | — | — | — | 5.00 | 5.00 | 5.00 |
| Sophorolipid | 5.00 | — | — | — | — | — |
| Fatty acyl | — | 5.00 | — | 2.00 | — | — |
| glutamate | | | | | | |
| Fatty acyl | 5.00 | — | — | — | — | — |
| glycinate | | | | | | |
| Corn starch | 5.00 | — | 5.00 | — | — | — |
| Sodium | — | 30.00 | 23.00 | 20.00 | 25.00 | — |
| cocoate | | | | | | |
| Sodium palm | 20.00 | — | — | — | — | 25.00 |
| kernelate | | | | | | |
| Glycerol | 2.00 | — | — | — | — | — |
| Sorbitol | — | — | — | — | 4.00 | 4.00 |
| Perfume | 1.00 | 0.50 | 1.00 | 1.00 | 1.00 | 1.00 |
| CI 77891 | 0.30 | 0.20 | 0.10 | 0.20 | 0.20 | 0.20 |
| Coconut acid | — | 1.50 | 1.50 | — | — | — |
| Palm kernel | 1.00 | — | — | — | — | — |
| acid | | | | | | |
| Tallow acid | — | 1.50 | 1.50 | — | — | — |
| Palm acid | 1.00 | — | — | — | — | — |
| Sodium | 0.30 | 0.20 | 0.30 | 0.50 | 0.50 | 0.50 |
| chloride | | | | | | |
| Sodium lactate | 0.10 | — | — | 0.10 | 0.10 | 0.10 |
| BHT | 0.05 | 0.05 | 0.05 | 0.05 | 0.05 | 0.05 |
| Tetrasodium | — | 0.10 | 0.10 | 0.05 | 0.05 | 0.05 |
| etidronate | | | | | | |
| Tetrasodium | 0.1 | 0.10 | 0.10 | 0.05 | 0.05 | 0.05 |
| EDTA | | | | | | |
| Niacinamide | — | — | — | — | — | — |
| Aloe | 0.2 | — | — | — | — | — |
| barbedensis | | | | | | |
| leaf juice | | | | | | |
| Lanolin | — | — | — | 2.00 | 2.00 | 2.00 |
| CI 47005 | — | — | — | — | — | — |
| CI 74160 | — | — | — | — | — | — |
| CI 77007 | — | — | — | — | — | — |
| Aqua | Total to | Total to | Total to | Total to | Total to | Total to |
| | 100 | 100 | 100 | 100 | 100 | 100 |

The soaps have a very good washing behavior, feeling on the skin and foaming performance, similar to the properties of combibars.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A soap which includes, each in wt. % based on the total weight of the soap:
(a) 0.5 to 90 wt. % sodium, potassium and/or ammonium salts of fatty acids having 6 to 30 carbon atoms, and
(b) 1 to 50 wt. % of one or more biosurfactants.

2. The soap according to claim 1, which includes
(a) 20 to 85 wt. % the sodium, potassium and/or ammonium salts of fatty acids having 6 to 30 carbon atoms, and
(b) 1 to 20 wt. % the one or more biosurfactants, each based on the total weight of the soap.

3. The soap according to claim 1, wherein sodium, potassium and/or ammonium salts of tallow fatty acids, coconut fatty acids, olive oil fatty acids, palm oil fatty acids, lard fatty acids, palm kernel oil fatty acids or a combination thereof, are included as component (a).

4. The soap according to claim 1, which includes a glycolipid, a lipopeptide or a combination thereof as the biosurfactant.

5. The soap according to claim 1, which includes a rhamnolipid, a sophorolipid, a mannosylerythritol, a surfactin, a fatty acyl glutamate, a fatty acyl glycinate or a combination thereof as the biosurfactant.

6. The soap according to claim 5, which includes a sophorolipid as the biosurfactant, wherein 20 to 60 wt. % is in the acidic form.

7. The soap according to claim 5, which includes a mixture of mono- and dirhamnolipid as the biosurfactant, which are each derived from 3-hydroxydodecanoic acid and 3-hydroxyundecanoic acid.

8. The soap according to claim 1, which further includes 0.1 to 10 wt. % of a non-ionic surfactant selected from the group consisting of polyglycoside(s), fatty acyl glucamide(s) and a combination thereof.

9. The soap according to claim 1, which includes 0.5 wt. % or less anionic, cationic, amphoteric and/or zwitterionic surfactants.

10. The soap according to claim 1, which further includes one or more components selected from the group consisting of fillers, free fatty acids, fragrances or perfumes, antioxidants, complexing agents, caring substances and humectants.
